(19) United States
(12) Patent Application Publication
(10) Pub. No.: US 2026/0037224 A1
(43) Pub. Date: Feb. 5, 2026

(54) GREEDY ALGORITHM FOR IN NETWORK COMPUTATION TREES

(71) Applicant: Cisco Technology, Inc., San Jose, CA (US)

(72) Inventors: Ayan Banerjee, Fremont, CA (US); Ramesh Sivakolundu, Saratoga, CA (US)

(21) Appl. No.: 18/794,734

(22) Filed: Aug. 5, 2024

(51) Int. Cl. G06F 7/57

(52) U.S. Cl. CPC G06F 7/57

(57) ABSTRACT

Techniques and architecture are described for a method that includes an in network compute (INC) manager receiving from switches of a fat tree configured network, arithmetic logic unit (ALU) capacity of the switches. Based at least in part on the ALU capacity of the switches and bandwidth, the INC manager determines one or more switches within each tier that are capable of supporting the processing units and based at least in part on the determining, the INC manager selects a first switch as a root, wherein the first switch is included within a tier of switches having intermediate tiers of switches located between the tier and the plurality of processing units within the fat tree configured network. The INC manager creates one or more paths of switches within each of the intermediate tiers from the root to the plurality of processing units to provide a constrained disjoint spanning tree of switches.

### TECHNICAL FIELD

The present disclosure relates generally to methods of handling artificial intelligence (AI)/machine learning (ML) workloads using disjoint spanning trees in fat tree configured networks configured for in network compute (INC), and more particularly, to methods of building constrained disjoint spanning trees in fat tree configured networks configured for INC using capabilities and constraints as announced by nodes, e.g., switches, in the fat tree configured networks for handling AI/ML workloads.

### BACKGROUND

As artificial intelligence (AI)/machine learning (ML) workloads in networks continue to rapidly increase, it is necessary to improve speed and efficiency of the networks that handle the AL/ML workloads. In an effort to reduce job completion times (JCT) for a typical AI-ML workload with in network compute (INC), trees are computed in the network based on network and resource availability. As of now, there are some proprietary algorithms that are used for this purpose. The construction of these trees is relatively static and do not account for failures.

The Ultra Ethernet Consortium (UEC) has had a standardized approach to signal some of the parameters that may be used for a tree building algorithm. However, there has been no mention of the algorithms themselves. Most of the other literature that is out there talks through building simple spanning trees on homogeneous networks.

More particularly, the literature has proposed rail-optimized or rail-only designs for AI-ML traffic. The idea behind most or all of these designs is to reduce the traffic between high-bandwidth domains (scale-up networks) and then use a scale-out network. INC aids in this effort in requiring even less bandwidth from the scale-out network. INC is being developed within a sub-group within the UEC that is chartered to aid AI-ML application traffic workloads to be offloaded to the switches. This aids in improving job completion time by reducing the amount of data that is transferred in the network. A typical reduction operation needs data to be transferred between a number of GPUs with a reduction function to be applied to the data from the past period of operation to be used in the next period of operation. This communication of data from the past period of operation when it progresses through the switches may have the appropriate functions applied based on the arithmetic-logical-unit (ALU) capacity of the switches. The standard body is focused on the control plane and data plane formats to be used for this purpose. However, there has been no mention of an algorithm to be used by a centralized entity (referred to as the INC manager) to setup the states at various nodes in the network.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 schematically illustrates an example an example of a network configured as a fat tree network, i.e., the network has a fat tree topology, configured to provide in network compute (INC), in accordance with techniques and architecture described herein.

FIGS. 2A and 2B schematically illustrate the network of FIG. 1 to describe operation of an algorithm used by an INC manager to build constrained disjoint spanning trees in fat tree configured networks, e.g., network 100, configured for INC using capabilities as announced by nodes, e.g., switches, in the fat tree configured networks for handling AI/ML workloads, in accordance with techniques and architecture described herein.

FIG. 3 illustrates a flow diagram of an example method for building constrained disjoint spanning trees in fat tree configured networks, e.g., network 100, configured for INC using capabilities as announced by nodes, e.g., switches, in the fat tree configured networks for handling AI/ML workloads, in accordance with the techniques and architecture described herein.

FIG. 4 is a computer architecture diagram showing an example computer hardware architecture for implementing a device that can be utilized to implement aspects of the various technologies presented herein.

### DESCRIPTION OF EXAMPLE EMBODIMENTS

### Overview

The present disclosure provides techniques and architecture for a method of handling artificial intelligence (AI)/machine learning (ML) workloads using disjoint spanning trees in fat tree configured networks configured for in network compute (INC), and more particularly, to methods of building constrained disjoint spanning trees in fat tree configured networks configured for INC using capabilities as announced by nodes, e.g., switches, in the fat tree configured networks for handling AI/ML workloads. In particular, the techniques and architecture provide a greedy algorithm that may be used based on a switch architecture design that may be developed with various hardware architectures and application specific circuits (ASICs). Using the techniques and architecture described herein may result in, for example, (a) blocking topologies (or non-blocking topologies due to failures or by design) job completion times (JCTs) being improved due to a reduction in the bandwidth required from the network and (b) by trading ALU processing time over propagation time, it is possible to improve JCTs.

Briefly, in configurations, the algorithm may begin with gathering information from leaves of a fat tree configured network, where the leaves include tiers of nodes, e.g., switches. The fat tree configured network also includes a collective of processing units, e.g., graphics processing units (GPUs) that communicate with one another via the tiers of nodes. At each tier, and at each node of the tier, the reachability and bandwidth availability of the node from a lower tier is checked. In the event, the node is able to be supported, a value of 1 is added to a running aggregate set of values. Note that the aggregation at a tier-X, when X is non-zero, simply adds the values that tier-X are able to aggregate and have bandwidth towards the higher tier. As an example, a couple of switches is able to support a collective of processing units since the array has non-zero values. This data collection is a recursive accumulation of reachability and ALU node availability and link bandwidth for the upper layer. Thus, an equation, for each index i at a node with tier-X, is the sum of the values of the index i at nodes in tier-(X-1), provided there is link resource availability between node Tier-X and its children connected to node tier-(X-1) and ALU processing availability at the node of tier (X-1). Both of these identities are readily available at the INC manager based on the current state of the network.

In configurations, the greedy algorithm may continue by starting from the nodes at the highest tier that have non-zero values in all indices. In configurations, a heuristic that may be followed is that the node that has the sum of the highest value of all indices is chosen as the root (intuitively this sets up with the largest number of paths from the root to all the GPUs). In the event there is a tie, in configurations, a simple random choice may be used to break the tie. The greedy algorithm recursively chooses the child that contributes the most towards the value and needs to pull in children if all GPUs are not covered in this downward flow.

As an example, a method, implemented within a fat tree configured network configured for in network compute (INC), wherein the fat tree configured network comprises a plurality of processing units, may comprise receiving, by an INC manager of the fat tree configured network from switches of the fat tree configured network, arithmetic logic unit (ALU) capacities of the switches, wherein the switches are arranged in tiers and the ALU capacities represent a maximum ALU capacity and a current ALU capacity of the switches. The method may also comprise based at least in part on the ALU capacity of the switches and bandwidth, first determining, by the INC manager, one or more switches within each tier that are capable of supporting the processing units and based at least in part on the first determining, selecting, by the INC manager, a first switch as a root, wherein the first switch is included within a tier of switches having intermediate tiers of switches located between the tier and the plurality of processing units within the fat tree configured network. The method may further comprise creating, by the INC manager, one or more paths of switches within each of the intermediate tiers from the root to the plurality of processing units to provide a constrained disjoint spanning tree among the tiers of switches, wherein the constrained disjoint spanning tree provides connectivity among the plurality of processing units. The method may additionally comprise executing, by the plurality of processing units and the switches, a collective computing operation.

### Example Embodiments

In accordance with configurations described herein, as previously noted, techniques and architecture are described herein for a method of handling artificial intelligence (AI)/machine learning (ML) workloads using trees in fat tree configured networks configured for in network compute (INC), and more particularly, to methods of building constrained disjoint spanning trees in fat tree configured networks configured for INC using capabilities as announced by nodes, e.g., switches, in the fat tree configured networks for handling AI/ML workloads. In particular, the techniques and architecture provide a greedy algorithm that may be used based on a switch architecture design that may be developed with various hardware architectures and application specific circuits (ASICs). Using the techniques and architecture described herein may result in, for example, (a) blocking topologies (or non-blocking topologies due to failures or by design) job completion times (JCTs) being improved due to a reduction in the bandwidth required from the network and (b) by trading arithmetic logic unit (ALU) processing time over propagation time, it is possible to improve JCTs. While the techniques and architecture are described primarily with respect to AI/ML workloads, the techniques and architecture are also applicable to other operations such as, for example, map-reduce operations, which are used in searches.

In general, all switches (nodes) of a fat tree configured network announce the ALU capacity of the node. Based on the hardware design, each ALU may be able to compute a number of reduction operations at a particular rate. Currently, it is possible to work off ALUs that can support computation at a rate of A gigabytes per second (GB/s) (A=400 GB/s, which works out to 3.2 terabits (Tb)/s). For a high-performance switch that supports S Tb/s capacity (in current designs, S is 25.6 Tb/s, 51.2 Tb/s), this implies that it is necessary to slice the aggregate bandwidth into K=S/A buckets (in this example, this works out to 8 or 16 such buckets). This parameter K is very important as it implies that any switch in the network cannot have more than K children to be part of a tree. Note that this value of “K” in a non-homogenous network may vary depending on the capability of the node. Another parameter that goes in hand with this is the data type that is feasible at this capacity, which is typically floating point (FP) 32 bit (FP32). In the event, there are different data types, there is a factor F that may be used to reduce the effective ALU bandwidth, e.g., A×F.

In configurations, as an example, K_i is used as the rail-optimized building block for the hierarchical INC flow. In general, the goal is to build a spanning tree whose degree is limited to K_i at each node. In general, starting from the spines of the network, a simple tree building algorithm may pull in K_i members from its next tier until the NICs that are connected to the processing units (e.g., graphical processing units (GPUS)) of the fat tree configured network are reached. In general, the tree is built based on the product of the switches' ALU capacity across the cross-section of its ports (the slices/buckets that were previously defined).

As an example for describing the algorithm, it is assumed that the fat tree configured network is a homogenous network built with switches that can support K children due to the network's processing capacity. Also, it is assumed that each GPU can send data at G (=400) GB/s and thus need to group a set of A/G (=8) GPUs for each ALU. Assume initially there are N (=1024) GPUs, then N/(A/G) (=1024/8=128) ALU domains are needed. Given that there are K domains that may be supported by a switch, [N/(A/G)]/K\hat{ }T switches are needed at each tier to support this reduction. In general, this implies that as tiers are moved across, a K-fold over-subscription may be supported.

In configurations, the algorithm may begin with gathering information from leaves of a fat tree configured network, where the leaves include tiers of nodes, e.g., switches. The fat tree configured network also includes a collective of processing units, e.g., graphics processing units (GPUs) that communicate with one another via the tiers of nodes. At each tier, and at each node of the tier, the reachability and bandwidth availability of the node from a lower tier is checked. In the event, the node is able to be supported, a value of 1 is added to a running aggregate set of values. Note that the aggregation at a tier-X, when X is non-zero, simply adds the values that tier-X are able to aggregate and have bandwidth towards the higher tier. As an example, a couple of switches is able to support a collective of processing units since the array has non-zero values. This data collection is a recursive accumulation of reachability and ALU node availability and link bandwidth for the upper layer. Thus, an equation, for each index i at a node with tier-X, is the sum of the values of the index i at nodes in tier-(X-1), provided there is link resource availability between nodeTier-X and its children connected to node tier-(X-1) and ALU processing availability at the node of tier (X-1). Both of these identities are readily available at the INC manager based on the current state of the network.

In configurations, the greedy algorithm may continue by starting from the nodes at the highest tier that have non-zero values in all indices. In configurations, a heuristic that may be followed is that the node that has the sum of the highest value of all indices is chosen as the root (intuitively this sets up with the largest number of paths from the root to all the GPUs). In the event there is a tie, in configurations, a simple random choice may be used to break the tie. The greedy algorithm recursively chooses the child that contributes the most towards the value and needs to pull in children if all GPUs are not covered in this downward flow.

The greedy algorithm thus starts from the spine, and depending on the number of the GPUs that are going to be a part of the collective operation, pulls in the switches at each tier. At each tier, it packs the buckets at each switch before pulling in another switch at that tier. This packing order being greedy ensures that traffic and ALU bandwidth is packed in the section of the network per group.

Accordingly, in configurations, a method, implemented within a fat tree configured network configured for in network compute (INC), wherein the fat tree configured network comprises a plurality of processing units, includes receiving, by an INC manager of the fat tree configured network from switches of the fat tree configured network, arithmetic logic unit (ALU) capacities of the switches, wherein the switches are arranged in tiers and the ALU capacities represent a maximum ALU capacity and a current ALU capacity of the switches. The method also includes based at least in part on the ALU capacity of the switches and bandwidth, first determining, by the INC manager, one or more switches within each tier that are capable of supporting the processing units and based at least in part on the first determining, selecting, by the INC manager, a first switch as a root, wherein the first switch is included within a tier of switches having intermediate tiers of switches located between the tier and the plurality of processing units within the fat tree configured network. The method further includes creating, by the INC manager, one or more paths of switches within each of the intermediate tiers from the root to the plurality of processing units to provide a constrained disjoint spanning tree among the tiers of switches, wherein the constrained disjoint spanning tree provides connectivity among the plurality of processing units. The method additionally includes executing, by the plurality of processing units and the switches, a collective computing operation.

In some configurations, the collective computing operation comprises an artificial intelligence (AI)/machine learning (ML) operation.

In further configurations, determining one or more switches within each tier that are capable of supporting the processing units comprises aggregating, by the INC manager, values related to switches within the tiers capable of supporting the processing units.

In configurations, the values comprise either a one or a zero, where one represents that a switch is capable of supporting a particular processing unit and zero represents that a switch is incapable of supporting a particular processing unit.

In some configurations, multiple switches within the tier have the highest aggregated number of scores with respect to processing units and selecting the first switch as the root further comprises randomly selecting the first switch as the root.

In further configurations, creating one or more paths of switches within each of the intermediate tiers from the root to the plurality of processing units comprises selecting, by the INC manager, switches within tiers having a highest aggregated score with respect to at least some of the processing units.

In some configurations, the method further includes selecting, by the INC manager, one or more additional switches within a tier to support at least one or more additional switches, wherein the one or more additional switches have an aggregated score of at least one with respect to the at least some of the processing units.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

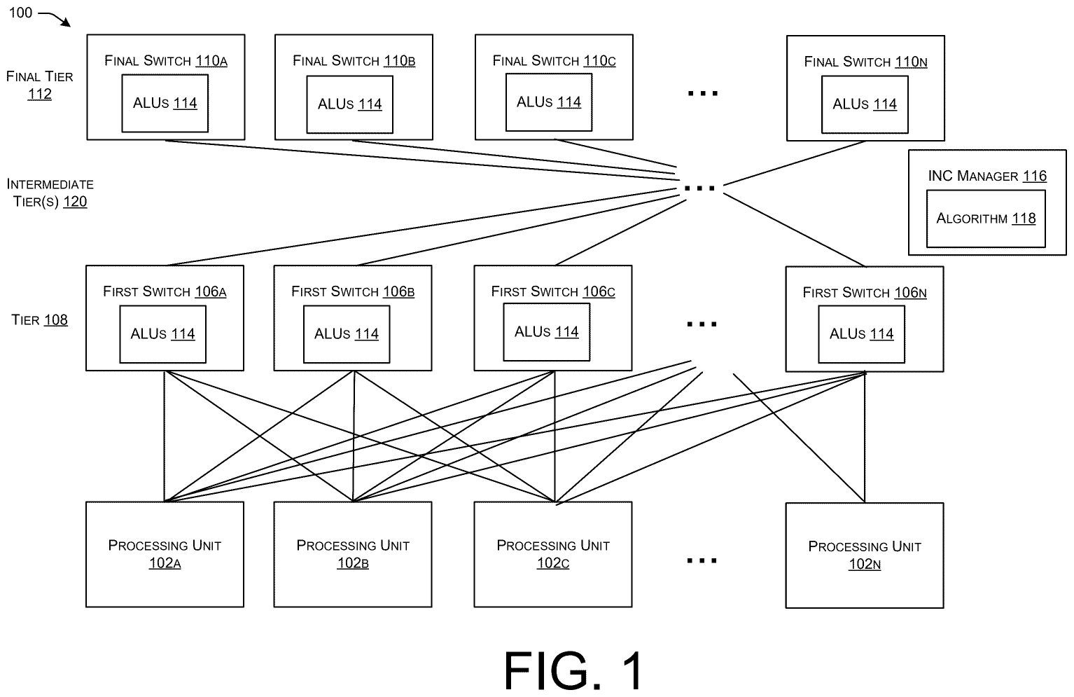

FIG. 1 schematically illustrates an example of a network 100 configured as a fat tree network, i.e., the network 100 has a fat tree topology, configured to provide in network compute (INC). The network 100 includes multiple processing units 102a-102n (referred to collectively as processing units 102). The processing units 102 may be in the form of graphics processing units (GPUs), digital processing units (DPUs), central processing units (CPUs), etc., each having their own network interface controller (NIC) 104. The network 100 also includes multiple first switches 106a-106n (referred to collectively as first switches 106) in a first tier 108 and multiple final switches 110a-110n (referred to collectively as final switches 110) in a final tier 112. One or more intermediate tiers 120 of switches (not illustrated) may be included between the first tier 108 and the final tier 112. While FIG. 1 includes processing units 102a-102n, first switches 106a-106n, and final switches 110a-110n, this does mean that there needs to be an equal number of each element and it should be noted that there may be any number of processing units 102, first switches 106, and final switches 110.

Each of the first switches 106 and final switches 110 include arithmetic logic units (ALUs) 114. The ALUs 114 may perform operations on traffic as the traffic traverses through the network 100.

An INC manager 116 manages the network 100 and the traffic within the network 100. The INC manager 116 is includes an algorithm 118 to create trees within the network 100 that provides routes within the network 100 through the various switches so that each of the processing units 102 is accessible via the first switches 104 and final switches 110 (and any intermediate switches). The trees need to include switches that have ALU 114 capacity and bandwidth to support selected processing units 102.

Briefly, in configurations, the algorithm 118 may begin with gathering information from switches (leaves) 104, 110 (and any intermediate switches) of the network 100. At each tier, and at each node (switch) of the tier, the reachability and bandwidth availability of the node from a lower tier is checked. In the event, the node is able to be supported, a value of 1 is added to a running aggregate set of values. Note that the aggregation at a tier-X, when X is non-zero, simply adds the values that tier-X are able to aggregate and have bandwidth towards the higher tier. As an example, a couple of switches is able to support a collective of processing units 102 since the array has non-zero values. This data collection is a recursive accumulation of reachability and availability of ALUs 114 and link bandwidth for the upper layer. Thus, an equation, for each index i at a node with tier-X, is the sum of the values of the index i at nodes in tier-(X-1), provided there is link resource availability between node Tier-X and its children connected to node tier-(X-1) and ALU processing availability at the node of tier (X-1). Both of these identities are readily available at the INC manager 116 based on the current state of the network 100.

In configurations, the algorithm 118 may continue by starting from the switches 110 at the final tier 112 that have non-zero values in all indices. In configurations, a heuristic that may be followed is that the switch 110 that has the sum of the highest value of all indices is chosen as the root of the tree (intuitively this sets up with the largest number of paths from the root to all the processing units 102). In the event there is a tie, in configurations, a simple random choice may be used to break the tie. The algorithm 118 recursively chooses the child (switch) that contributes the most towards the value and needs to pull in children if all processing units 102 are not covered in this downward flow.

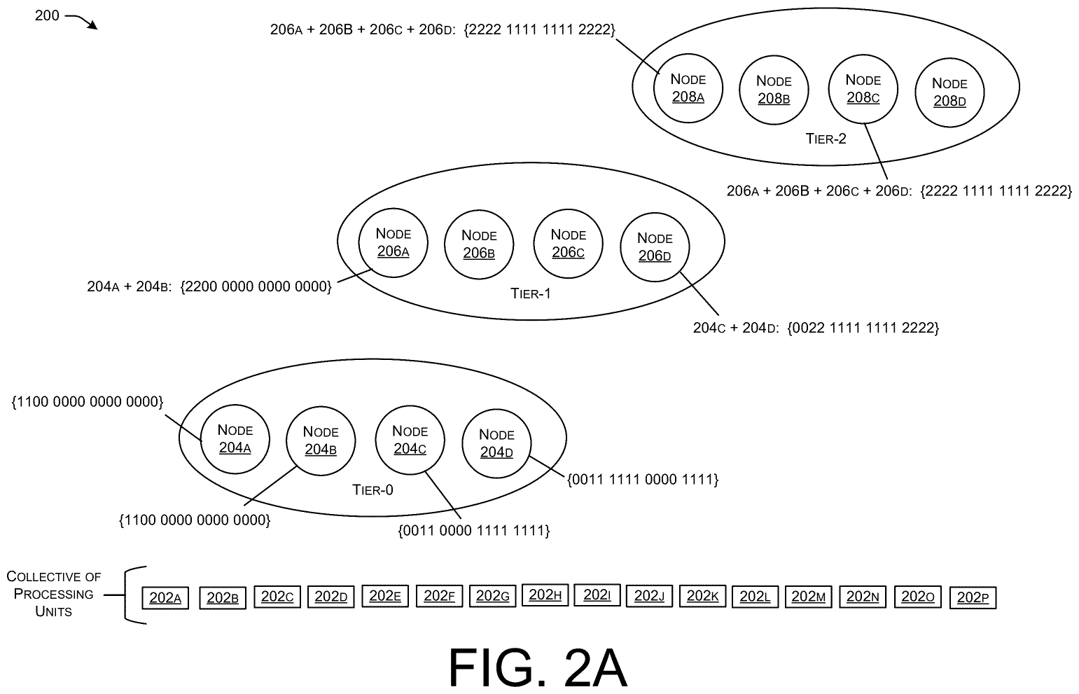

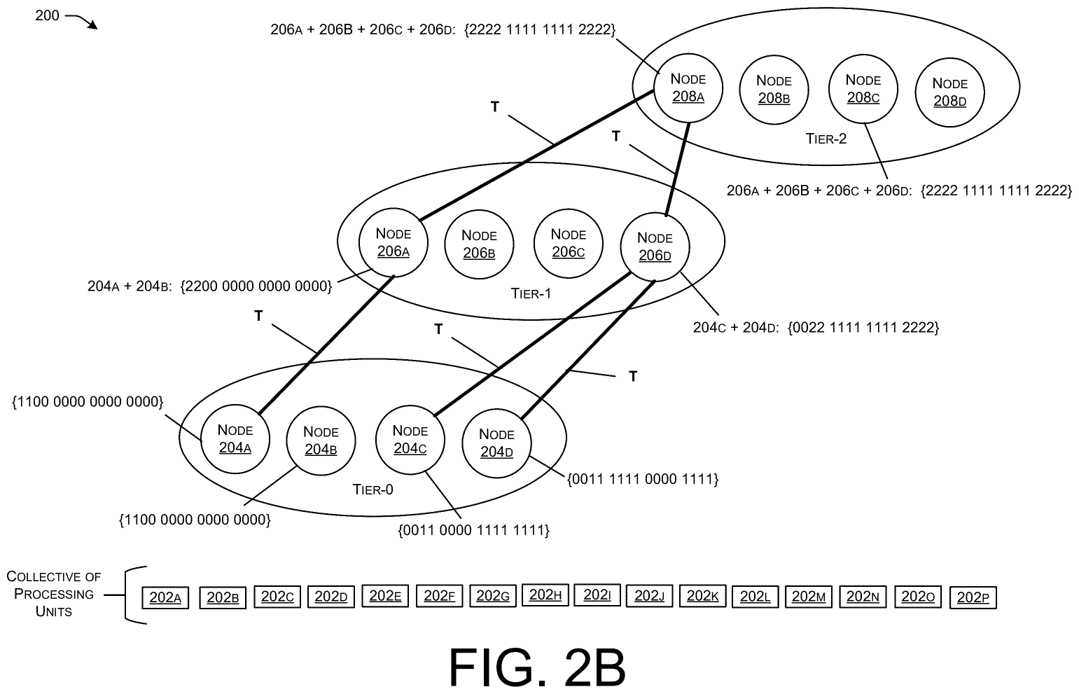

FIG. 2A schematically illustrates an example arrangement 200 of a network, e.g., network 100, for describing the algorithm 118 in greater detail. The example arrangement 200 includes sixteen processing units 202a-202p (referred to collectively as processing units 202). The processing units 202 generally correspond to the processing units 102 of FIG. 1. As is known, there are generally more processing units 202, although in configurations, there may be fewer processing units 202. The example arrangement 200 also includes a first tier Tier-0, a second tier Tier-1, and a final tier Tier-2. Tier-0 includes four nodes (e.g., switches) 204a-204d (referred to collectively as nodes 204). Tier-1 includes four nodes (e.g., switches) 206a-206d (referred to collectively as nodes 206). Tier-2 includes four nodes (e.g., switches) 208a-208d (referred to collectively as nodes 208). The nodes 204, 206, and 208 generally correspond to the switches 106 and the switches 110 (and any intermediate switches) of FIG. 1. As is known, there are generally more nodes 204, 206, and 208, although in configurations, there may be fewer nodes. Each of the nodes 204, 206, and 208 include ALUs (not illustrated). Additionally, as is known, there may be more tiers, although in configurations, there may be fewer tiers.

In configurations, the algorithm 118 may begin with gathering information from the nodes 204, 206, and 208. FIG. 2A includes a simple array of the processing units 202 that intend to be part of a collective of the network, e.g., the fat tree configured network of FIG. 1. FIG. 2A only illustrates the first sixteen processing units 202 for clarity, but as previously noted, there may be a much larger set of processing units 202.

At each tier, and at each node of the tier, the reachability and ALU bandwidth availability of the node from the lower tier is checked. In the event, a node is able to provide support, a value of 1 is added. For example, in FIG. 2A, the values (representing processing unit reachability and availability metadata) {1100 0000 0000 0000} at the node 204a of Tier-0 implies that the node 204a is able to support/aggregate results only from processing units 202a and 202b, whereas the values of {0011 0000 1111 1111} at the node 204c of Tier-0 implies that node 204c is able to support/aggregate results and send towards the root of a tree for all the processing units 202c, 202d, and 202i-p based on indices that have non-zero values. The values of {0011 1111 0000 1111} at the node 204d of Tier-0 implies that node 204d is able to support/aggregate results and send towards the root of a tree for all the processing units 202c-202h and 202m-p based on indices that have non-zero values. The number of elements within the values are generally equal to the number of processing units within a collective group of processing units 202, which in this example is sixteen.

In configurations, the aggregation at Tier-X, when X is non-zero, simply adds the values that the nodes are able to aggregate and have bandwidth towards the higher tier. Thus, at Tier-1, node 206a has a value of {2200 0000 0000 0000}, which is the aggregated value of nodes 204a and 204b of Tier-0 ({1100 0000 0000 0000}+{1100 0000 0000 0000}). Also, node 206d of Tier-1 has a value of {0022 1111 1111 2222}, which is the aggregated value of nodes 204c and 204d of Tier-0 ({0011 0000 1111 1111}+{0011 1111 0000 1111}).

Continuing with the example of FIG. 2A, nodes 208a and 208c of Tier-2 are able to support the collective of processing units 202a-202p since the array has non-zero values. Specifically, node 208a has an aggregated value of {2222 1111 1111 2222}, which is the aggregated value of nodes 206a, 206b, 206c, and 206d of Tier-1, while node 208c also has an aggregated value of {2222 1111 1111 2222}, which is the aggregated value of nodes 206a, 206b, 206c, and 206d of Tier-1. This data collection is a recursive accumulation of reachability and availability of ALUs at the nodes 204, 206, and 208 and link bandwidth for the upper layer (Tier-2). Thus, a simple equation is for each index i at a node with Tier-X, is the sum of the values of the index i at nodes in Tier-(X-1), provided there is link resource availability between node-Tier-X and its children connected to node-Tier-(X-1) and ALU processing availability at the node of Tier-(X-1). Both of these identities are readily available at the INC manager, e.g., INC manager 116, based on the current state of the network.

FIG. 2B schematically illustrates the example arrangement 200 of the network, e.g., network 100, for further describing the algorithm 118 in greater detail. The algorithm 118 may continue by starting from the nodes 208a-208d at the highest-tier, e.g., Tier-2, that have non-zero values in all indices. In this example, nodes 208a and 208c are both eligible in setting up the tree T as the root. In configurations, the heuristic that may be followed by the algorithm 118 is that the node that is chosen has the sum of the highest value of all indices (intuitively this sets up with the largest number of paths from the root to all the processing units 202). In the event there is a tie, in configurations a simple random choice may be made to select a node as the root. The algorithm 118 may recursively choose the child (node) that contributes the most towards the value and may need to pull in children (nodes) if all processing units 202 are not covered in this downward flow.

As can be seen in FIGS. 2A and 2B both nodes 208a and 208c have aggregated values of {2222 1111 1111 2222}. Assume node 208a is randomly selected by the algorithm 118 as the root, the algorithm 118 may pull in child node 206d (larger weight of 2222 in the aggregated value of {0022 1111 1111 2222}), and then 206a ({2200 0000 0000 0000}) may be selected because of the Os in the aggregated value of node 206d ({0022 1111 1111 2222}). On the next recursive step, the algorithm 118 may choose nodes 204c ({aggregated value 0011 0000 1111 1111}) and node 204d ({aggregated value 0011 1111 0000 1111}). The algorithm 118 may make a random choice between nodes 204a and 204b as leaves of the tree. For this example, assume the algorithm 118 selects node 204a.

Thus, in the example of FIGS. 2A and 2B, processing units 202a and 202b are covered by nodes 204a, 206a, and 208a. Processing units 202c and 202d are covered by nodes 204c, 206d, and 208a. Processing units 202e-h are covered by nodes 204d, 206d, and 208a. Processing units 202i-2021 are covered by nodes 204c, 206d, and 208a. Processing units 202m-202p may be covered by nodes 204c, 204d, 206d, and 208a.

Accordingly, a tree T that includes nodes 204a, 204c, 204d, 206a, 206d, and 208c within the network has been chosen. The ALU and bandwidth resources may be marked such that another future request in this sample fat-tree topology may be calculated effectively later. Note that with rail-optimized topology, this algorithm may work as a special case for a number of tier calculations. Also, it should be clear that based on the ALU capability of the nodes being non-homogenous, the algorithm 118 may complete its heuristic to best fit the collective operation of the processing units 202 based on the available resources. The tree T may be used to execute collective computing operations or workloads, e.g., AI/ML collective computing operations. More particularly, ALUs of the nodes of the trees, e.g., switches of the trees, may be used to more efficiently and/or quickly execute collective computing operations or workloads, e.g., AI/ML collective computing operations, in conjunction with the processing units 202.

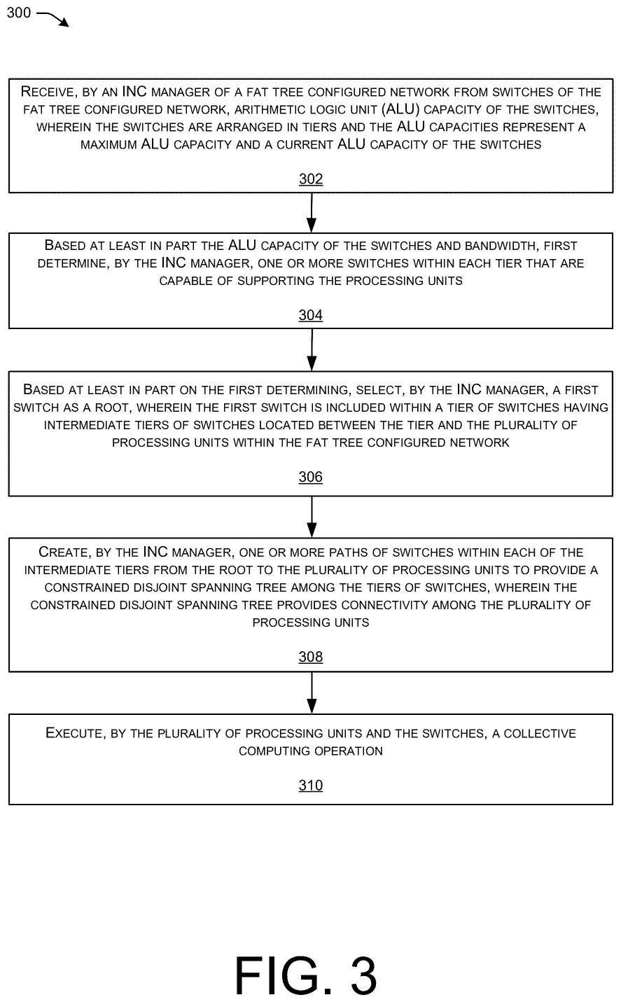

FIG. 3 illustrates a flow diagram of an example method 300 and illustrates aspects of the functions performed at least partly by devices of a network as described with respect to FIGS. 1, 2A, and 2B. The logical operations described herein with respect to FIG. 3 may be implemented (1) as a sequence of computer-implemented acts or program modules running on a computing system, and/or (2) as interconnected machine logic circuits or circuit modules within the computing system.

The implementation of the various components described herein is a matter of choice dependent on the performance and other requirements of the computing system. Accordingly, the logical operations described herein are referred to variously as operations, structural devices, acts, or modules. These operations, structural devices, acts, and modules can be implemented in software, in firmware, in special purpose digital logic, and any combination thereof. It should also be appreciated that more or fewer operations might be performed than shown in FIG. 3 and described herein. These operations can also be performed in parallel, or in a different order than those described herein. Some or all of these operations can also be performed by components other than those specifically identified. Although the techniques described in this disclosure are with reference to specific components, in other examples, the techniques may be implemented by less components, more components, different components, or any configuration of components.

FIG. 3 illustrates a flow diagram of an example method 300 for building constrained disjoint spanning trees in fat tree configured networks, e.g., network 100, configured for INC using capabilities as announced by nodes, e.g., switches, in the fat tree configured networks for handling AI/ML workloads. In some examples, the method 300 may be performed by a system comprising one or more processors and one or more non-transitory computer-readable media storing computer-executable instructions that, when executed by the one or more processors, cause the one or more processors to perform the method 300.

At 302, an INC manager of a fat tree configured network receives, from switches of the fat tree configured network, arithmetic logic unit (ALU) capacities of the switches, wherein the switches are arranged in tiers and the ALU capacities represent a maximum ALU capacity and a current ALU capacity of the switches. For example, in configurations, the algorithm 118 may begin with gathering information from the nodes 204, 206, and 208. FIG. 2A includes a simple array of the processing units 202 that intend to be part of a collective of the network, e.g., the fat tree configured network of FIG. 1. FIG. 2A only illustrates the first sixteen processing units 202 for clarity, but as previously noted, there may be a much larger set of processing units 202.

At 304, based at least in part on the ALU capacity of the switches and bandwidth, the INC manager first determines one or more switches within each tier that are capable of supporting the processing units. For example, at each tier, and at each node of the tier, the reachability and ALU bandwidth availability of the node from the lower tier is checked. In the event, a node is able to provide support, a value of 1 is added. For example, in FIG. 2A, the values (representing processing unit reachability and availability metadata) {1100 0000 0000 0000} at the node 204a of Tier-0 implies that the node 204a is able to support/aggregate results only from processing units 202a and 202b, whereas the values of {0011 0000 1111 1111} at the node 204c of Tier-0 implies that node 204c is able to support/aggregate results and send towards the root of a tree for all the processing units 202c, 202d, and 202i-p based on indices that have non-zero values. The values of {0011 1111 0000 1111} at the node 204d of Tier-O implies that node 204d is able to support/aggregate results and send towards the root of a tree for all the processing units 202c-202h and 202m-p based on indices that have non-zero values. The number of elements within the values are generally equal to the number of processing units within a collective group of processing units 202, which in this example is sixteen.

In configurations, the aggregation at Tier-X, when X is non-zero, simply adds the values that the nodes are able to aggregate and have bandwidth towards the higher tier. Thus, at Tier-1, node 206a has a value of {2200 0000 0000 0000}, which is the aggregated value of nodes 204a and 204b of Tier-0 ({1100 0000 0000 0000}+{1100 0000 0000 0000}). Also, node 206d of Tier-1 has a value of {0022 1111 1111 2222}, which is the aggregated value of nodes 204c and 204d of Tier-0 ({0011 0000 1111 1111}+{0011 1111 0000 1111}).

Continuing with the example of FIG. 2A, nodes 208a and 208d of Tier-2 are able to support this collective of processing units 202a-202p since the array has non-zero values. Specifically, node 208a has an aggregated value of {2222 1111 1111 2222}, which is the aggregated value of nodes 206a, 206b, 206c, and 206d of Tier-1, while node 208c also has an aggregated value of {2222 1111 1111 2222}, which is the aggregated value of nodes 206a, 206b, 206c, and 206d of Tier-1. This data collection is a recursive accumulation of reachability and availability of ALUs at the nodes 204, 206, and 208 and link bandwidth for the upper layer (Tier-2). Thus, a simple equation is for each index i at a node with Tier-X, is the sum of the values of the index i at nodes in Tier-(X-1), provided there is link resource availability between node-Tier-X and its children connected to node-Tier-(X-1) and ALU processing availability at the node of Tier-(X-1). Both of these identities are readily available at the INC manager, e.g., INC manager 116, based on the current state of the network.

At 306, based at least in part on the first determining, the INC manager selects a first switch as a root, wherein the first switch is included within a tier of switches having intermediate tiers of switches located between the tier and the plurality of processing units within the fat tree configured network. At 308 the INC manager, one or more paths of switches within each of the intermediate tiers from the root to the plurality of processing units to provide a constrained disjoint spanning tree among the tiers of switches, wherein the constrained disjoint spanning tree provides connectivity among the plurality of processing units. For example, FIG. 2B schematically illustrates the example arrangement 200 of a network, e.g., network 100, for further describing the algorithm 118 in greater detail. The algorithm 118 may continue by starting from the nodes 208a-208d at the highest-tier, e.g., Tier-2, that have non-zero values in all indices. In this example, node 208a and 208c are both eligible in setting up the tree T as the root. In configurations, the heuristic that may be followed by the algorithm 118 is that the node that is chosen has the sum of the highest value of all indices (intuitively this sets up with the largest number of paths from the root to all the processing units 202). In the event there is a tie, in configurations a simple random choice may be made to select a node as the root. The algorithm 118 may recursively choose the child (node) that contributes the most towards the value and may need to pull in children (nodes) if all processing units 202 are not covered in this downward flow.

As can be seen in FIGS. 2A and 2B both nodes 208a and 208c have aggregated values of {2222 1111 1111 2222}. Assume node 208a is randomly selected by the algorithm 118 as the root, the algorithm 118 may pull in child node 206d (larger weight of 2222 in the aggregated value of {0022 1111 1111 2222}), and then 206a ({2200 0000 0000 0000}) may be selected because of the Os in the aggregated value of node 206d ({0022 1111 1111 2222}). On the next recursive step, the algorithm 118 may choose nodes 204c ({aggregated value 0011 0000 1111 1111}) and node 204d ({aggregated value 0011 1111 0000 1111}). The algorithm 118 may make a random choice between nodes 204a and 204b as leaves of the tree. For this example, assume the algorithm 118 selects node 204a.

Thus, in the example of FIGS. 2A and 2B, processing units 202a and 202b are covered by nodes 204a, 206a, and 208a. Processing units 202c and 202d are covered by nodes 204c, 206d, and 208a. Processing units 202e-h are covered by nodes 204d, 206d, and 208a. Processing units 2021-2021 are covered by nodes 204c, 206d, and 208a. Processing units 202m-202p may be covered by nodes 204c, 204d, 206d, and 208a.

Accordingly, a tree T that includes nodes 204a, 204c, 204d, 206a, 206d, and 208c within the network has been chosen. The ALU and bandwidth resources may be marked such that another request in this sample tree may be calculated effectively. Note that with rail-optimized topology, this algorithm may work as a special case for a number of tier calculations. Also, it should be clear that based on the ALU capability of the nodes being non-homogenous, the algorithm 118 may complete its heuristic to best fit the collective operation of the processing units 202 based on the available resources.

At 310, the plurality of processing units and the switches execute a collective computing operation. For example, the tree T may be used to execute workloads, e.g., AI/ML workloads. ALUs of the nodes of the trees, e.g., switches of the trees, may be used to more efficiently and/or quickly execute collective computing operations or workloads, e.g., AI/ML collective computing operations, in conjunction with the processing units 202.

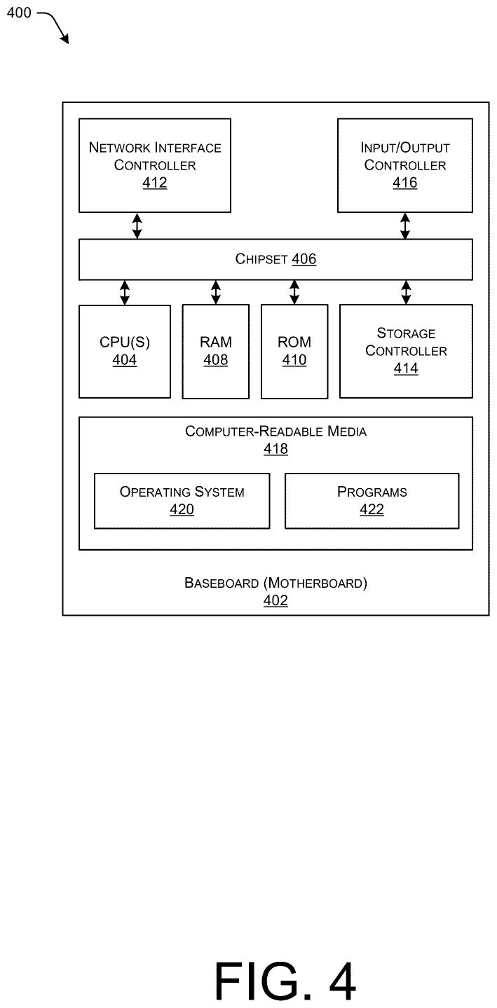

FIG. 4 shows an example computer architecture for a computing device 400 capable of executing program components for implementing the functionality described above. In configurations, one or more of the computing devices 400 may be used to implement one or more of the components of FIGS. 1, 2A, 2B, and 3. The computer architecture shown in FIG. 4 illustrates a conventional server computer, router, switch, workstation, desktop computer, laptop, tablet, network appliance, e-reader, smartphone, or other computing device, and can be utilized to execute any of the software components presented herein. The computing device 400 may, in some examples, correspond to a physical device or resources described herein.

The computing device 400 includes a baseboard 402, or “motherboard,” which is a printed circuit board to which a multitude of components or devices can be connected by way of a system bus or other electrical communication paths. In one illustrative configuration, one or more central processing units (“CPUs”) 404 operate in conjunction with a chipset 406. The CPUs 404 can be standard programmable processors that perform arithmetic and logical operations necessary for the operation of the computing device 400. One or more of the CPUs 404 may be replaced by one or more GPUs and/or one or more DPUs.

The CPUs 404 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 406 provides an interface between the CPUs 404 and the remainder of the components and devices on the baseboard 402. The chipset 406 can provide an interface to a RAM 408, used as the main memory in the computing device 400. The chipset 406 can further provide an interface to a computer-readable storage medium such as a read-only memory (“ROM”) 410 or non-volatile RAM (“NVRAM”) for storing basic routines that help to startup the computing device 400 and to transfer information between the various components and devices. The ROM 410 or NVRAM can also store other software components necessary for the operation of the computing device 400 in accordance with the configurations described herein.

The computing device 400 can operate in a networked environment using logical connections to remote computing devices and computer systems through a network. The chipset 406 can include functionality for providing network connectivity through a NIC 412, such as a gigabit Ethernet adapter. In configurations, the NIC 412 can be a smart NIC (based on data processing units (DPUs)) that can be plugged into data center servers to provide networking capability. The NIC 412 is capable of connecting the computing device 400 to other computing devices over networks. It should be appreciated that multiple NICs 412 can be present in the computing device 400, connecting the computer to other types of networks and remote computer systems.

The computing device 400 can include a storage device 418 that provides non-volatile storage for the computer. The storage device 418 can store an operating system 420, programs 422, and data, which have been described in greater detail herein. The storage device 418 can be connected to the computing device 400 through a storage controller 414 connected to the chipset 406. The storage device 418 can consist of one or more physical storage units. The storage controller 414 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computing device 400 can store data on the storage device 418 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 418 is characterized as primary or secondary storage, and the like.

For example, the computing device 400 can store information to the storage device 418 by issuing instructions through the storage controller 414 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 400 can further read information from the storage device 418 by detecting the physical states or characteristics of one or more particular locations within the physical storage units.

In addition to the mass storage device 418 described above, the computing device 400 can have access to other computer-readable storage media to store and retrieve information, such as program modules, data structures, or other data. It should be appreciated by those skilled in the art that computer-readable storage media is any available media that provides for the non-transitory storage of data and that can be accessed by the computing device 400. In some examples, the operations performed by the cloud network, and or any components included therein, may be supported by one or more devices similar to computing device 400. Stated otherwise, some or all of the operations described herein may be performed by one or more computing devices 400 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 418 can store an operating system 420 utilized to control the operation of the computing device 400. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 418 can store other system or application programs and data utilized by the computing device 400.

In one embodiment, the storage device 418 or other computer-readable storage media is encoded with computer-executable instructions which, when loaded into the computing device 400, transform the computer from a general-purpose computing system into a special-purpose computer capable of implementing the embodiments described herein. These computer-executable instructions transform the computing device 400 by specifying how the CPUs 404 transition between states, as described above. According to one embodiment, the computing device 400 has access to computer-readable storage media storing computer-executable instructions which, when executed by the computing device 400, perform the various processes described above with regard to FIGS. 1, 2A, 2B, and 3. The computing device 400 can also include computer-readable storage media having instructions stored thereupon for performing any of the other computer-implemented operations described herein.

The computing device 400 can also include one or more input/output controllers 416 for receiving and processing input from a number of input devices, such as a keyboard, a mouse, a touchpad, a touch screen, an electronic stylus, or other type of input device. Similarly, an input/output controller 416 can provide output to a display, such as a computer monitor, a flat-panel display, a digital projector, a printer, or other type of output device. It will be appreciated that the computing device 400 might not include all of the components shown in FIG. 4, can include other components that are not explicitly shown in FIG. 4, or might utilize an architecture completely different than that shown in FIG. 4.

The computing device 400 may support a virtualization layer, such as one or more virtual resources executing on the computing device 400. In some examples, the virtualization layer may be supported by a hypervisor that provides one or more virtual machines running on the computing device 400 to perform functions described herein. The virtualization layer may generally support a virtual resource that performs at least portions of the techniques described herein.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method within a fat tree configured network configured for in network compute (INC), wherein the fat tree configured network comprises a plurality of processing units, the method comprising:
receiving, by an INC manager of the fat tree configured network from switches of the fat tree configured network, arithmetic logic unit (ALU) (maximum and current) capacities of the switches, wherein the switches are arranged in tiers and the ALU capacities represent a maximum ALU capacity and a current ALU capacity of the switches;
based at least in part on the ALU capacity of the switches and bandwidth, first determining, by the INC manager, one or more switches within each tier that are capable of supporting the processing units;
based at least in part on the first determining, selecting, by the INC manager, a first switch as a root, wherein the first switch is included within a tier of switches having intermediate tiers of switches located between the tier and the plurality of processing units within the fat tree configured network;
creating, by the INC manager, one or more paths of switches within each of the intermediate tiers from the root to the plurality of processing units to provide a constrained disjoint spanning tree among the tiers of switches, wherein the constrained disjoint spanning tree provides connectivity among the plurality of processing units; and
executing, by the plurality of processing units and the switches, a collective computing operation.

2. The method of claim 1, wherein the collective computing operation comprises an artificial intelligence (AI)/machine learning (ML) operation.

3. The method of claim 1, wherein determining one or more switches within each tier that are capable of supporting the processing units comprises:
aggregating, by the INC manager, values related to switches within the tiers capable of supporting the processing units.

4. The method of claim 3, wherein:
the values comprise either a one or a zero;
one represents that a switch is capable of supporting a particular processing unit; and
zero represents that a switch is incapable of supporting a particular processing unit.

5. The method of claim 4, wherein selecting the first switch as the root comprises:
selecting the first switch based on the first switch having a highest aggregated number of scores with respect to processing units.

6. The method of claim 5, wherein multiple switches within the tier have the highest aggregated number of scores with respect to processing units and selecting the first switch as the root further comprises:
randomly selecting the first switch as the root.

7. The method of claim 5, wherein creating one or more paths of switches within each of the intermediate tiers from the root to the plurality of processing units comprises:
selecting, by the INC manager, switches within tiers having a highest aggregated score with respect to at least some of the processing units.

8. The method of claim 7, further comprising:
selecting, by the INC manager, one or more additional switches within a tier to support at least one or more additional switches, wherein the one or more additional switches have an aggregated score of at least one with respect to the at least some of the processing units.

9. A system implemented within a fat tree configured network configured for in network compute (INC), wherein the fat tree configured network comprises a plurality of processing units, the system comprising:
one or more processors; and
one or more non-transitory computer-readable media storing computer-executable instructions that, when executed by the one or more processors, cause the one or more processors to perform actions comprising:
receiving, by an INC manager of the fat tree configured network from switches of the fat tree configured network, arithmetic logic unit (ALU) capacities of the switches, wherein the switches are arranged in tiers and the ALU capacities represent a maximum ALU capacity and a current ALU capacity of the switches;
based at least in part on the ALU capacity of the switches and bandwidth, first determining, by the INC manager, one or more switches within each tier that are capable of supporting the processing units;
based at least in part on the first determining, selecting, by the INC manager, a first switch as a root, wherein the first switch is included within a tier of switches having intermediate tiers of switches located between the tier and the plurality of processing units within the fat tree configured network;
creating, by the INC manager, one or more paths of switches within each of the intermediate tiers from the root to the plurality of processing units to provide a constrained disjoint spanning tree among the tiers of switches, wherein the constrained disjoint spanning tree provides connectivity among the plurality of processing units; and
executing, by the plurality of processing units and the switches, a collective computing operation.

10. The system of claim 9, wherein the collective computing operation comprises an artificial intelligence (AI)/machine learning (ML) operation.

11. The system of claim 9, wherein determining one or more switches within each tier that are capable of supporting the processing units comprises:
aggregating, by the INC manager, values related to switches within the tiers capable of supporting the processing units.

12. The system of claim 11, wherein:
the values comprise either a one or a zero;
one represents that a switch is capable of supporting a particular processing unit; and
zero represents that a switch is incapable of supporting a particular processing unit.

13. The system of claim 12, wherein selecting the first switch as the root comprises:
selecting the first switch based on the first switch having a highest aggregated number of scores with respect to processing units.

14. The system of claim 13, wherein multiple switches within the tier have the highest aggregated number of scores with respect to processing units and selecting the first switch as the root further comprises:
randomly selecting the first switch as the root.

15. The system of claim 13, wherein creating one or more paths of switches within each of the intermediate tiers from the root to the plurality of processing units comprises:
selecting, by the INC manager, switches within tiers having a highest aggregated score with respect to at least some of the processing units.

16. The system of claim 15, further comprising:
selecting, by the INC manager, one or more additional switches within a tier to support at least one or more additional switches, wherein the one or more additional switches have an aggregated score of at least one with respect to the at least some of the processing units.

17. One or more non-transitory computer-readable media storing computer-executable instructions that, when executed by one or more processors, cause the one or more processors to perform actions within a fat tree configured network configured for in network compute (INC), wherein the fat tree configured network comprises a plurality of processing units, the actions comprising:
receiving, by an INC manager of the fat tree configured network from switches of the fat tree configured network, arithmetic logic unit (ALU) capacities of the switches, wherein the switches are arranged in tiers and the ALU capacities represent a maximum ALU capacity and a current ALU capacity of the switches;
based at least in part on the ALU capacity of the switches and bandwidth, first determining, by the INC manager, one or more switches within each tier that are capable of supporting the processing units;
based at least in part on the first determining, selecting, by the INC manager, a first switch as a root, wherein the first switch is included within a tier of switches having intermediate tiers of switches located between the tier and the plurality of processing units within the fat tree configured network;
creating, by the INC manager, one or more paths of switches within each of the intermediate tiers from the root to the plurality of processing units to provide a constrained disjoint spanning tree among the tiers of switches, wherein the constrained disjoint spanning tree provides connectivity among the plurality of processing units; and
executing, by the plurality of processing units and the switches, a collective computing operation.

18. The one or more non-transitory computer-readable media of claim 17, wherein determining one or more switches within each tier that are capable of supporting the processing units comprises:
aggregating, by the INC manager, values related to switches within the tiers capable of supporting the processing units,
wherein:
the values comprise either a one or a zero;
one represents that a switch is capable of supporting a particular processing unit; and
zero represents that a switch is incapable of supporting a particular processing unit.

19. The one or more non-transitory computer-readable media of claim 18, wherein selecting the first switch as the root comprises:
selecting the first switch based on the first switch having a highest aggregated number of scores with respect to processing units.

20. The one or more non-transitory computer-readable media of claim 18, wherein creating one or more paths of switches within each of the intermediate tiers from the root to the plurality of processing units comprises:
selecting, by the INC manager, switches within tiers having a highest aggregated score with respect to at least some of the processing units,
wherein the actions further comprise selecting, by the INC manager, one or more additional switches within a tier to support at least one or more additional switches, wherein the one or more additional switches have an aggregated score of at least one with respect to the at least some of the processing units.
